(19) United States
(12) Patent Application Publication
(10) Pub. No.: US 2006/0248139 A1
(43) Pub. Date: Nov. 2, 2006

(54) NETWORKED COMPUTER MANAGEMENT WITH A MOBILE SOFTWARE AGENT

(75) Inventor: Murali Sundar, Hillsboro, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/379,016

(22) Filed: Apr. 17, 2006

Related U.S. Application Data
(63) Continuation of application No. 09/451,802, filed on Dec. 1, 1999, now abandoned.

(51) Int. Cl. G06F 15/173; G06F 15/16

(52) U.S. Cl. 709/202; 709/224

(57) ABSTRACT

The invention provides a method of managing the state of networked computers. A preferred state is specified, and selected networked computers to be maintained in the preferred state are defined. The networked computers are monitored for deviation from the preferred state, and are brought to the preferred state if they deviate by a mobile software agent that travels autonomously between the selected networked computers.

This application is a Continuation of U.S. application Ser. No. 09/451,802 filed on Dec. 1, 1999 which is incorporated herein by reference.

### FIELD OF THE INVENTION

The invention relates generally to managing the state of computers, and more specifically to a software agent to manage the state of computers that are interconnected via a network.

### BACKGROUND OF THE INVENTION

Corporations, educational facilities, and other owners of large numbers of computers face the difficult task of managing their computers to ensure they are operating properly and configured as desired. This often involves manually fixing problems with computers as they are reported by users, leaving a computer inoperable for some time. Further, problems that are not detected and reported by users and are not otherwise evident may go unfixed, leaving a computer in an undesired state.

It is desirable in many such circumstances to configure computers that are used for similar tasks in the same manner, to ease the burden of managing a different configuration for each system. These computers may share the same hardware, software, CMOS configuration, or other attributes, so that a computer that has become misconfigured can be easily restored to a common desired state. Some degree of automation in the configuration of similarly configured computers can then be employed, reducing the effort needed to maintain a desired state among large groups of computers.

Software applications may be installed on these computers, and subsequently deleted or damaged by users. Such an action need not be intentional, but can result from deletion of a file or simple installation or deletion of software seemingly unrelated to the installed application. Also, user-installed software may be subject to licensing requirements not purchased or otherwise met by the computer owner, causing potential legal liability. Viruses may further affect the software installed on these computers, and can spread relatively quickly when these computers are networked or used by multiple users.

The hardware installed on each system is also vulnerable to a variety of alterations from a desired state. A computer's CMOS may be altered to configure the hardware of a computer in a way that is not preferred by the computer owner, requiring resetting of correct parameters. Also, the newest driver software for installed hardware may be desired, or a specific driver software version may be desired for use on all machines to make management of hardware incompatibilities easier. Users may add or remove hardware from computer systems, making monitoring of the actual hardware associated with each system a part of managing the state of the computers. Monitoring the hardware installed on each computer system is also desirable for inventory purposes, and to determine whether certain computers have sufficient hardware to support desired software applications adequately.

Various methods of managing some of these states of computers have been employed in software that enables some degree of configuration capability over a network, but are not as easy to use or as scalable as is desired. An easy way of managing the state of interconnected computers in and efficient and scalable manner with minimal impact on network resources is therefore desired.

### SUMMARY

The invention provides a method of managing the state of networked computers. A preferred state is specified, and selected networked computers to be maintained in the preferred state are defined. The networked computers are monitored for deviation from the preferred state, and are brought to the preferred state if they deviate by a mobile software agent that travels autonomously between the selected networked computers.

### BRIEF DESCRIPTION OF THE FIGURES

FIG. 1 shows networked computers connected to a host computer, consistent with an embodiment of the present invention.

FIG. 2 shows software modules, consistent with an embodiment of the present invention.

FIG. 3 shows a flowchart consistent with an embodiment of the invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention addresses the previously discussed problems associated with management of the state of a large number of networked computers. It provides a configurable mobile software agent, capable of traveling autonomously between networked computers. The mobile software agent of the present invention includes functions such as monitoring computers on a network to ensure they are in a preferred state, bringing computers that deviate from the preferred state to the preferred state, and autonomously traveling between the computers on the network and reporting the status of the software agent to a host computer. A mobile software agent may only provide some of these functions or may perform additional functions, and may also rely on other software agents to perform some of these functions or related functions such as are described herein.

Detailed explanation of several embodiments of managing the state of networked computers with mobile software agents is given below, along with a discussion of how the mobile software agents of the invention may interact in various embodiments with other software and hardware within a network.

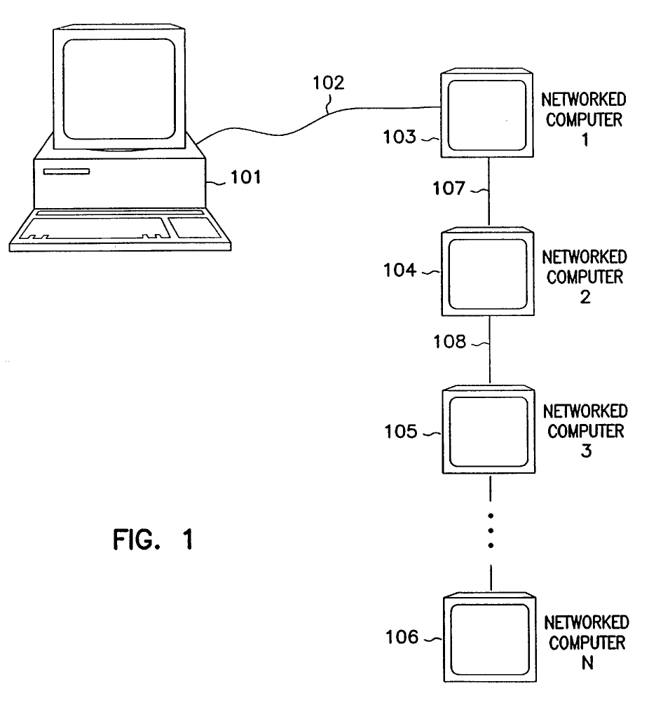

FIG. 1 illustrates a typical network configuration with a variety of computer systems interconnected by a network. A host computer 101 is connected by a network connection 102 to a number N of networked computers. The networked computers 1, 2, and 3 shown at 103, 104, and 105 are further connected via network connections 107 and 108, and are connected to a number of other computers in the network, up to computer N shown at 106 via additional network connections. Therefore, the host computer and networked computers 1 through N are connected via a network that facilitates communication between the computers.

In operation, a computer such as host computer 101 serves as the host for a mobile software agent. Software executing on the host computer generates the user-configurable mobile software agent, which is then sent via a network connection such as 102 to the networked computers.

In practicing the invention, one or more preferred configurations are first defined so that a mobile software agent can sense the state of the networked computers and make appropriate changes to bring them to one of the preferred configurations. Preferred configurations may be set by a user specifying a specific configuration to be maintained on selected machines, or may be based on a set of rules defined by a user that makes a configuration decision based on these rules as the mobile software agent visits each machine. For example, a mobile software agent may decide upon visiting each networked computer to download and install a new virus signature file only if the current virus signature file is more than three months old for normal systems or more than one month old for networked computers designated as servers. In an alternate embodiment, the preferred configuration may be automatically generated, based on a computer system currently in the preferred configuration. In some embodiments, the mobile software agent may contain multiple preferred state configurations, such as in the previous example, so that a single mobile software agent can configure networked systems with different preferred states.

The mobile software agent of various embodiments of the invention performs various functions as it travels autonomously from computer to computer. A specialized mobile software agent known as a knowledge-finding agent or monitoring agent is employed in various embodiments to seek information relating to the state of computers connected to the network. Such an agent operates to travel autonomously between networked computers, to detect and report networked computer configuration information back to the host computer. For example, a knowledge-finding agent can search networked computers to determine hardware configuration so that the information can be compiled for inventory purposes or to verify that computers have adequate hardware to run certain software applications. The knowledge-finding agent can also inventory software installed on the networked computers such that the inventory can be used to verify that proper versions or software patches are installed, or to verify compliance with software licensing requirements. A knowledge-finding agent may also be used to search out within a specified network space those computer systems that are not known to the host computer, enabling the host computer to maintain a current list of networked computers to be maintained.

The functions of the knowledge-finding agent may also be performed by a mobile software agent that performs other functions, such as software installation or other preferred state update functions. Such a mobile software agent then would both perform both knowledge-finding functions and configuration functions as it traveled between networked computers.

Knowledge-finding agents in a further embodiment can be created automatically to discover new computers or sub-networks in a selected network space without user intervention, and can bring newly detected computers to a preferred state or can simply alert a user that new systems have been detected.

A mobile software agent in one embodiment performs configuration functions needed to bring a networked computer to the preferred state for that specific computer during the period of time it resides on the computer. After the mobile software agent has completed its task, it copies itself to another networked computer, and then erases itself from the computer on which it has completed working. In a further embodiment, the mobile software agent sends a trip report to the host computer after completing work on each networked computer, or at any other regular interval, before the mobile software agent has traveled to and completed work on all networked machines it must visit. An alternate embodiment includes providing a trip report to the host system only after the mobile software agent has visited all networked machines it must visit, but this embodiment is not preferred.

If a mobile software agent were to visit a computer that becomes disconnected from the network or whose user ceases to regularly use the computer, the mobile software agent may become unable to forward itself to the next machine in a timely manner. For this reason, regular trip reports are preferred, and may be used to ensure timely progression of the mobile software agent. A lost mobile software agent can then be replaced with a substitute mobile software agent that performs the same task as the original mobile software agent, and need not visit those computers that the trip reports reflect have already been successfully visited by the lost mobile software agent. In a further embodiment, the mobile software agent has a finite life span, and will discontinue operation a certain period of time after initial release or after residing on the same computer for a certain period of time.

Once the mobile software agent is fully installed on a networked computer, it changes the hardware or software configuration of the computer as needed to bring the computer to the preferred configuration state. The preferred configuration may include in various embodiments details such as hardware drivers, software patches or updates, hardware settings or configuration, software settings or configuration, or versions of other computer data such as a virus signature file. Any of these or other similar configuration elements may be monitored and updated by the mobile software agents of the present invention.

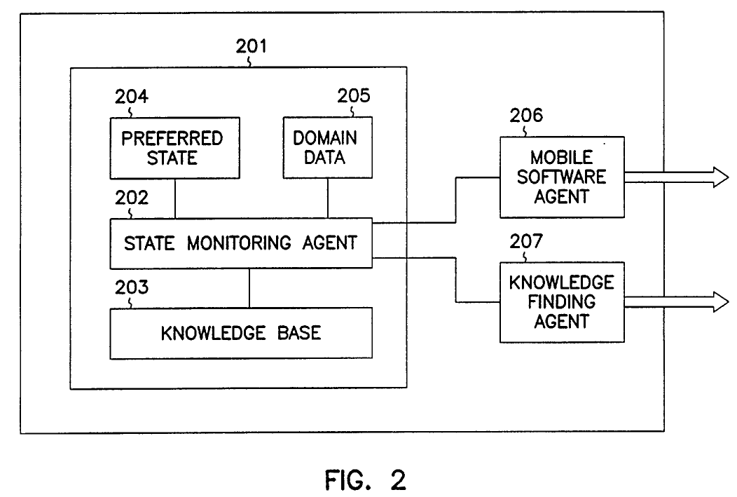

In one specific embodiment of the present invention, the host computer executes software that comprises a number of modules as shown in FIG. 2. A module called a solution cube at 201 comprises a state monitoring agent 202, a knowledge base 203, preferred state data 204, and domain data 205. The solution cube contains the information needed to generate and manage the mobile software agents of the invention, such as mobile software agent 206 and knowledge-finding agent 207.

In operation, the state monitoring agent receives data from the knowledge-finding agent 207 and stores it in the knowledge base 203. The knowledge-finding agents are directed to search selected networked computers according to domain data 205. The knowledge base data in 203 is compared to preferred state data 204, and the mobile software agent 206 performs actions needed to bring the selected networked computers to the preferred state. The solution cube module 201 may reside on a host system such as is shown at 101 from which it generates and controls the mobile software agent 206 and knowledge-finding agent 207 that travel between networked computers. In an alternate embodiment, one or more solution cube modules can reside on any networked computer, and there provides support for the mobile software agents that visit the node.

Each networked computer must have software that facilitates travel of the mobile software agents, and embodiments where various functions of the solution cube module or mobile software agents are performed by the facilitating software are to be considered within the scope of the invention. For example, a state monitoring agent may comprise a part of the facilitating software, and may manage data relating to the computer it resides on and data comprising the mobile software agents to perform the task of keeping the computer in a preferred state. In a further embodiment, the facilitating software may forward the data comprising the mobile software agents to the next computer according to the data of the mobile software agent and erase the data after successful completion of necessary tasks, thereby facilitating the task of autonomous travel of the mobile software agents.

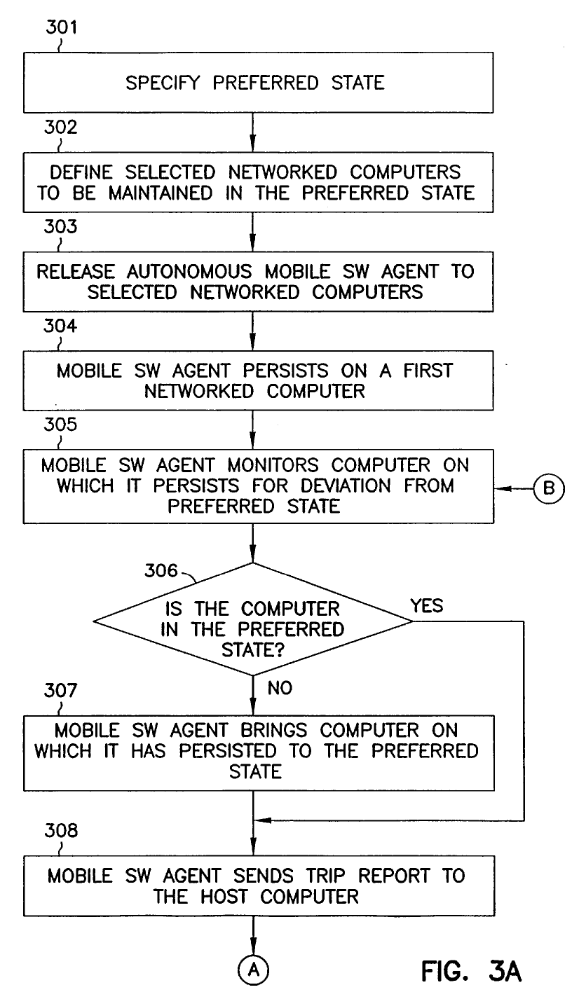

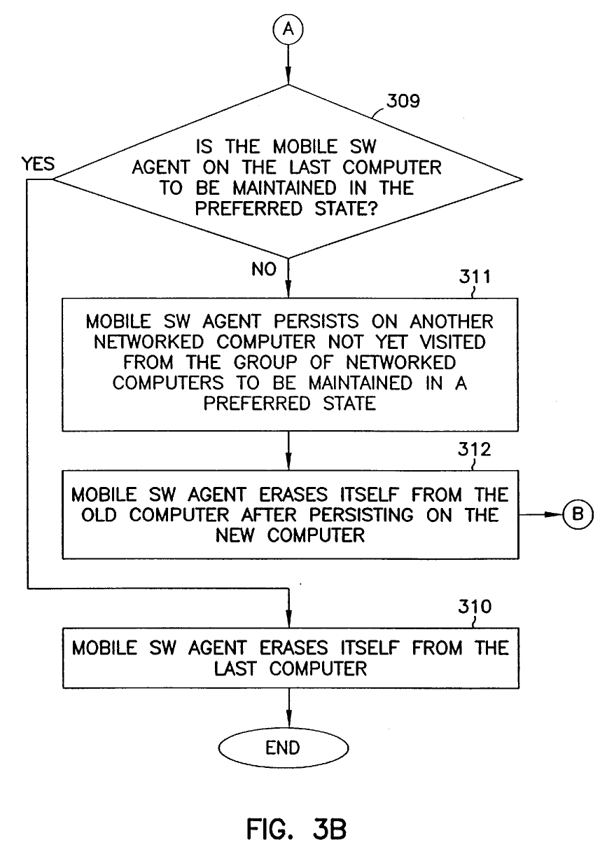

FIG. 3 shows a flowchart of an embodiment of the invention, illustrating how the mobile software agents can be employed to manage the state of a distributed network of computers. At 301, a preferred state for computers is defined. The preferred state may include hardware, software, or other computer configuration information, and multiple preferred states may be defined for different computers. At 302, selected networked computers to be kept in each of the specified preferred states are defined. At 303, a host computer releases an autonomous mobile software agent to travel among the defined selected networked computers. At 304, the mobile software agent persists on a first networked computer. At 305, the mobile software agent monitors the computer on which it currently persists for deviation from the preferred state. At 306, the mobile software agent determines whether the computer is in the preferred state.

If the computer is in the preferred state, the mobile software agent sends a trip report reflecting this to the host computer at 308. If the computer is not in the preferred state, the mobile software agent performs actions to bring the computer to the preferred state at 307 before proceeding to send a trip report at 308. At 309, the mobile software agent determines whether it has visited the last of the selected networked computers to be maintained in the preferred state. If it has, it erases itself from the last computer at 310, having completed its task. If it has not, it persists on another networked computer not yet visited from the group of networked computers to be maintained in the specified preferred state at 311. After persisting on a new networked computer, the mobile software agent erases itself from the old computer on which it had first persisted, and exists solely on the new computer at 312. After persisting on the new computer, the mobile software agent monitors the new computer for deviation from the preferred state at 305, and continues this process until it has visited all selected networked computers to be maintained in the specified preferred state.

In other embodiments, the mobile software agent that monitors for deviation from a preferred state may be independent of the mobile software agent that brings computers to the preferred state. For example, a relatively small knowledge-finding agent may visit a large number of computers to ensure that a selected version of an application is installed, and may then send a very large mobile software agent containing the application code to only those few computers that need the application installed. Such a method reduces time and network bandwidth required to complete the task, because the full application code need only be transferred between networked computers that need the application code installed.

Other embodiments include defining actions needed to bring a computer to a preferred state as part of specifying the preferred state, and defining multiple preferred states and configurations depending on the networked computer visited. For example, a single software agent may service both word processing computers and graphics computers, and configure their resources differently based on the intended use of the computer. Alternatively, separate mobile software agents may be created for each type of machine, so that specialized mobile software agents visit only machines that are to be identically configured. Still other embodiments and configurations of mobile software agents exist, and are to be considered within the scope of the invention.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof

We claim:

1. A method of managing the state of networked computers, comprising:
specifying a preferred state;
defining selected networked computers to be maintained in the preferred state;
monitoring the selected networked computers for deviation from the preferred state; and
bringing the selected networked computers that deviate from the preferred state to the preferred state via a mobile software agent that travels autonomously between the selected networked computers.

2. The method of claim 1, wherein specifying a preferred state comprises:
defining a preferred software configuration of a computer; and
defining actions needed to bring the computer to the desired software configuration if the computer is not in the preferred software configuration.

3. The method of claim 1, wherein defining selected computers to be maintained in the preferred state comprises generating a list of networked computers to be maintained in the preferred state.

4. The method of claim 3, wherein the mobile software agent autonomously travels between the selected networked computers by traveling to the computers on the list of networked computers to be maintained in the preferred state.

5. The method of claim 1, wherein defining selected computers to be maintained in the preferred state comprises defining a network space of computers to be maintained in the preferred state.

6. The method of claim 5, wherein the mobile software agent autonomously travels between the selected networked computers by traveling to the computers in the networked space of computers to be maintained in the preferred state.

7. The method of claim 1, wherein monitoring the selected networked computers for deviation from a preferred state is performed via a mobile monitoring agent.

8. The method of claim 7, wherein the mobile agent travels autonomously between the selected networked computers.

9. The method of claim 1, wherein the mobile software agent that brings the selected networked computers that deviate from the preferred state to the preferred state also performs the monitoring the selected networked computers for deviation from the preferred state by first monitoring each selected networked computer it travels to for deviation from the preferred state and subsequently bringing the computer to the preferred state if it deviates from the preferred state.

10. The method of claim 1, wherein the mobile software agent travels autonomously between the selected networked computers by transferring itself from a present computer to a next computer, and erasing itself from the present computer after it has successfully transferred itself to the next computer.

11. The method of claim 1, further comprising providing a trip report from the mobile software agent to a host system.

12. The method of claim 1, wherein the mobile software agent is further operable to travel to computers not among the selected networked computers to transfer data.

13. The method of claim 12, wherein the mobile software agent maintains the trip report that is reported to a host computer upon return of the mobile software agent to the host computer.

14. The method of claim 12, wherein the mobile software agent sends a trip report to the host computer periodically as it travels between the selected networked computers.

15. The method of claim 1, wherein the selected networked computers have a mobile software agent host program thereon to facilitate mobile software agent travel and execution.

16. A machine-readable medium with instructions stored thereon, the instructions operable when executed to cause a computer to:
receive and store data defining a preferred state of computers;
receive and store data defining selected networked computers to be maintained in the preferred state;
generate a mobile software agent that travels autonomously between the selected networked computers and brings the selected networked computers that deviate from the preferred state to the preferred state.

17. A machine-readable medium with instructions stored thereon, the instructions operable when executed to cause a computer to:
generate a mobile software agent that travels autonomously between selected networked computers that deviate from a preferred state to the preferred state.

18. A machine-readable medium with instructions stored thereon, the instructions operable when executed to cause a computer to:
monitor a first networked computer for deviation from a preferred state;
bring the first networked computer to the preferred state if it deviates from the preferred state; and
copy the executable instructions operable to perform the monitoring, bringing to a preferred state, and copying functions to a second networked computer.

19. The machine-readable medium of claim 18, with further instructions operable when executed to cause a computer to remove the executable instructions operable to perform the monitoring, bringing to a preferred state and copying functions from the first networked computer after the instructions are successfully copied to the second networked computer.

20. A computerized networked computer management system, comprising:
a networked computer server, operable to generate a mobile software agent that travels autonomously between networked computers, monitors the networked computers for deviation from a preferred state, and brings the selected computers that deviate from the preferred state to the preferred state.

21. A method of managing the state of networked computers, comprising:
specifying a preferred state;
defining selected networked computers to be maintained in the preferred state;
monitoring the selected networked computers for deviation from the preferred state; and
bringing the selected networked computers that deviate from the preferred state to the preferred state via a mobile software agent that is sent to the selected networked computers.
